(19) United States
(12) Patent Application Publication
(10) Pub. No.: US 2017/0240273 A1
(43) Pub. Date: Aug. 24, 2017

(54) FIXED-WING VTOL AIRCRAFT WITH ROTORS ON OUTRIGGERS

(71) Applicant: Melville Yuen, Honolulu, HI (US)

(72) Inventor: Melville Yuen, Honolulu, HI (US)

(21) Appl. No.: 15/052,773

(22) Filed: Feb. 24, 2016

(51) Int. Cl. B64C 29/00; B64D 27/02

(52) U.S. Cl. CPC B64C 29/0033; B64D 27/02

(57) ABSTRACT

The VTOL aircraft of the present invention has fixed-wings which can be monoplane, biplane or tri-plane and tiltable rotors on outriggers which extend from the fuselage and/or wings. The rotors on the outriggers can be driven by engines located in the fuselage or wings via a transmission system such as a shaft, pulley, or pressurized air using pumps. If rotors are driven by jets at the tips, fuel is fed through pipes inside of the outriggers. The rotors and engines can be located at the ends of the outriggers or the rotors may be separate from the engines and tilting only the rotors reduces structural requirements and weight of the aircraft. The rotors can be tilted over ninety degrees from the vertical position forwards and backwards, sideways if needed for lateral movement. The outriggers can be configured in various ways depending upon how many rotors are used and where the engines are located. Placing rotors on outriggers in the spaces least obstructed by the wings and fuselage reduces drag which increases efficiency and also offers a flexible platform for various hybrid designs.

### FIELD OF ART

The present invention relates to a fixed-wing vertical take-off and landing (VTOL) aircraft having rotors on outriggers. The present invention more particularly relates VTOL aircraft having pivotal propulsion elements.

### BACKGROUND OF THE INVENTION

Fixed-wing VTOL aircraft present the most difficult challenges in aerospace engineering, as the transition between vertical, direct-thrust, flight and horizontal, wing-borne, flight raises serious stability problems. The Harrier aircraft uses vectored thrust from jet engine compressor bleed air for vertical, direct-thrust, flight and traditional jet engine power for wing-borne flight. The Osprey aircraft uses tilt rotors on the ends of fixed-wings for vertical takeoff and tilts the engines and rotors to transition to wing-borne flight. In vertical flight, part of the rotor-propelled air impinges on the top surface of the wing, reducing effective thrust. In wing-borne flight, the wing receives rotor-propelled air from only one side of the engine.

What is needed is a VTOL aircraft using multiple smaller rotors on outriggers, such that the rotor-propelled air is least obstructed by part of the wing or fuselage.

### SUMMARY OF THE INVENTION

The VTOL aircraft of the present invention has fixed-wings which can be monoplane, biplane or tri-plane and tiltable or fixed rotors on outriggers which extend from the fuselage and/or wings. The rotors on the outriggers can be driven by engines located in the fuselage or wings via a transmission system such as a shaft, pulley, or pressurized air using pumps. If rotors are driven by jets at the tips, fuel is fed through pipes inside of the outriggers. The rotors and engines can be located at the ends of the outriggers like multi rotor drones ‘with electric engines otherwise it is preferable to separate them if the engine is heavy since separating the rotors from the engines and tilting only the rotors reduces structural requirements and weight of the aircraft.

The rotors can be tilted over ninety degrees from the vertical position forwards and backwards, sideways if needed for lateral movement. The outriggers can be configured in various ways depending upon how many rotors are used and where the engines are located. Placing rotors on outriggers in the spaces least obstructed by the wings and fuselage reduces drag which increases efficiency and also offers a flexible platform for various hybrid designs.

Multiple rotors has the advantage of smaller diameter and lighter rotors blades, lower structural requirements, smaller gears, reduced weight, better stability and control of aircraft, higher rotor rpm to attain higher speeds in horizontal flight, added safety if one is damaged, and longer range. In case of engine failure, wings add stability and increase the glide ratio. If the length of the rotors are short so it won't touch the ground when tilted in line with forward flight, it can be flown as a fixed-wing aircraft on take-off and landing which increases load capacity. Submitted embodiments are not inclusive of all possible designs. The placement of rotors away from the fuselage and wings allows for simple and inexpensive installation of ballistic parachutes if desired.

### DESCRIPTION OF THE FIGURES OF THE DRAWINGS

The present invention will hereinafter be described in conjunction with the following drawing figures, wherein like numerals denote like elements, and

FIG. 1 is a top plan diagrammatic view illustrating an exemplary embodiment of the fixed-wing VTOL aircraft with rotors on outriggers, according to a preferred embodiment of the present invention;

FIG. 2 is a side elevation diagrammatic view illustrating the exemplary embodiment of the fixed-wing VTOL aircraft with rotors on outriggers of FIG. 1, according to a preferred embodiment of the present invention;

FIG. 3 is a front elevation diagrammatic view illustrating the exemplary embodiment of the fixed-wing VTOL aircraft with rotors on outriggers of FIG. 1 in a non-flight configuration, according to a preferred embodiment of the present invention;

FIG. 4 is a top plan diagrammatic view illustrating a second exemplary embodiment of the fixed-wing VTOL aircraft with rotors on outriggers, according to a preferred embodiment of the present invention;

FIG. 5 is a side elevation diagrammatic view illustrating the second exemplary embodiment of the fixed-wing VTOL aircraft with rotors on outriggers of FIG. 4, according to a preferred embodiment of the present invention;

FIG. 6 is a front elevation diagrammatic view illustrating the second exemplary embodiment of the fixed-wing VTOL aircraft with rotors on outriggers of FIG. 4, according to a preferred embodiment of the present invention;

FIG. 7 is a top plan diagrammatic view illustrating a third exemplary embodiment of the fixed-wing VTOL aircraft with rotors on outriggers, according to a preferred embodiment of the present invention;

FIG. 8 is a side elevation diagrammatic view illustrating the third exemplary embodiment of the fixed-wing VTOL aircraft with rotors on outriggers of FIG. 7, according to a preferred embodiment of the present invention;

FIG. 9 is a front elevation diagrammatic view illustrating the third exemplary embodiment of the fixed-wing VTOL aircraft with rotors on outriggers of FIG. 7, according to a preferred embodiment of the present invention;

FIG. 10 is a top plan diagrammatic view illustrating a fourth exemplary embodiment of the fixed-wing VTOL aircraft with rotors on outriggers, according to a preferred embodiment of the present invention;

FIG. 11 is a side elevation diagrammatic view illustrating the fourth exemplary embodiment of the fixed-wing VTOL aircraft with rotors on outriggers of FIG. 10, according to a preferred embodiment of the present invention;

FIG. 12 is a front elevation diagrammatic view illustrating the fourth exemplary embodiment of the fixed-wing VTOL aircraft with rotors on outriggers of FIG. 10, according to a preferred embodiment of the present invention;

FIG. 13 is a top plan diagrammatic view illustrating a fifth exemplary embodiment of the fixed-wing VTOL aircraft with rotors on outriggers, according to a preferred embodiment of the present invention;

FIG. 14 is a side elevation diagrammatic view illustrating the fifth exemplary embodiment of the fixed-wing VTOL aircraft with rotors on outriggers of FIG. 13, according to a preferred embodiment of the present invention;

FIG. 15 is a front elevation diagrammatic view illustrating the fifth exemplary embodiment of the fixed-wing VTOL aircraft with rotors on outriggers of FIG. 13 in a non-flight configuration, according to a preferred embodiment of the present invention;

FIG. 16 is a top plan diagrammatic view illustrating a fifth exemplary embodiment of the fixed-wing VTOL aircraft with rotors on outriggers, according to a preferred embodiment of the present invention;

FIG. 17 is a front elevation diagrammatic view illustrating the fifth exemplary embodiment of the fixed-wing VTOL aircraft with rotors on outriggers of FIG. 16, according to a preferred embodiment of the present invention; and

FIG. 18 is a side elevation diagrammatic view illustrating the fifth exemplary embodiment of the fixed-wing VTOL aircraft with rotors on outriggers of FIG. 16 with a cut-away portion, according to a preferred embodiment of the present invention.

### DETAILED DESCRIPTION OF THE INVENTION

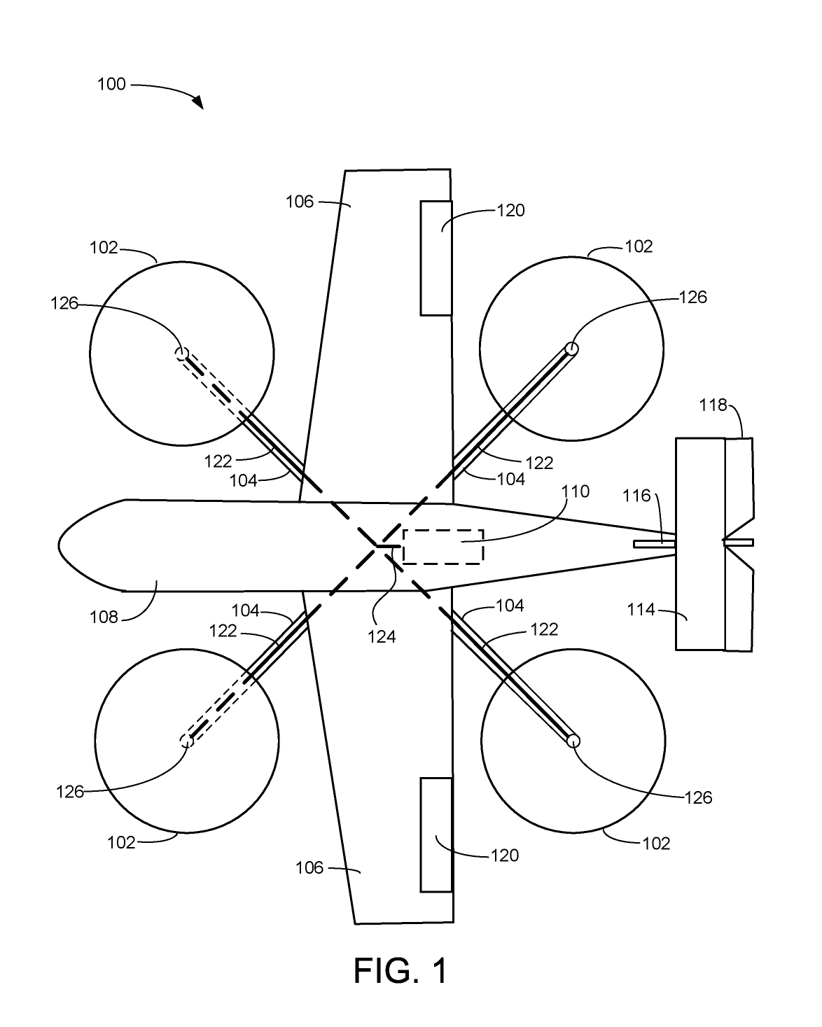

FIG. 1 is a top plan diagrammatic view illustrating an exemplary embodiment of the fixed-wing VTOL aircraft 100 with rotors 102 on outriggers 104, according to a preferred embodiment of the present invention. Fuselage 108, including structural members therein, supports wings 106 with flight control surfaces 120 (such as ailerons 120) and a vertical stabilizer 116 further supporting horizontal stabilizer 114 having a flight control surface 118 (such as an elevator 118). Fuselage 108 further supports outriggers 104 which house drive shafts 122 coupled between motor output shaft 124 and rotational couplings 126. In some embodiments, fuselage 108 may support an emergency ballistic parachute that can deploy if the aircraft 100 is disabled. Motor output shaft 124 is driven by motor 110, which is located within the fuselage 108. Coupling between the motor output shaft 124 and the drive shafts 122 may, in various embodiments, be of any suitable configuration, within the constraints of reliability and weight reduction. Motor 110 may, in various embodiments, be any type of motor, from a battery-operated electric motor 110 for a toy drone to a combustion motor 110 (piston or jet) for a large aircraft 100.

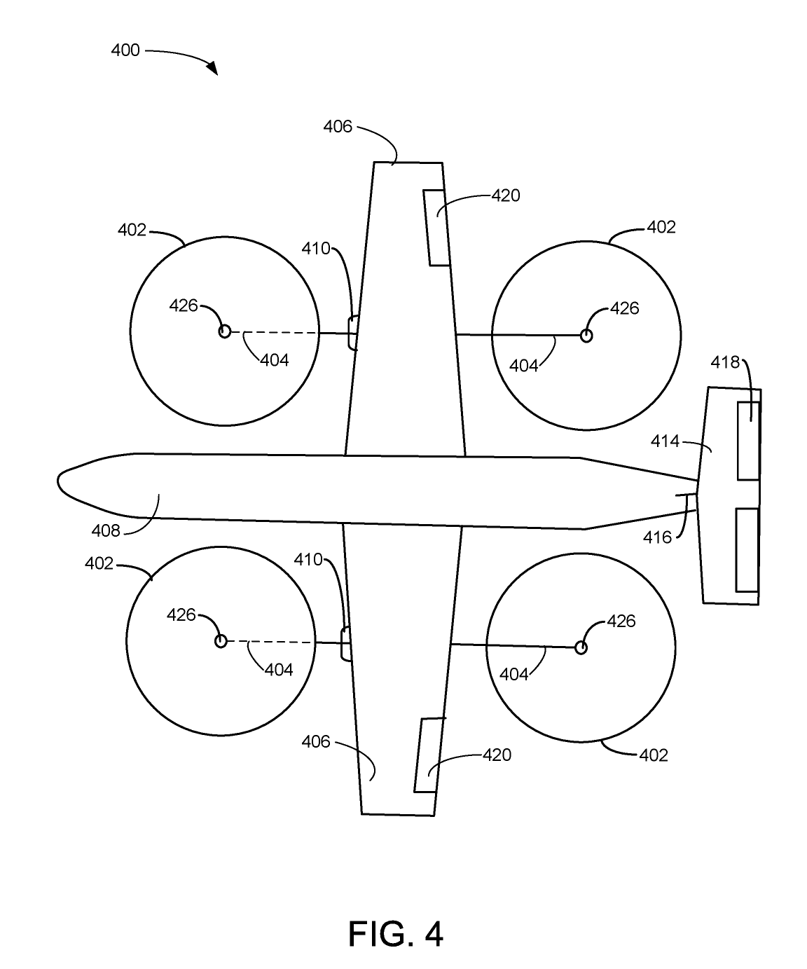

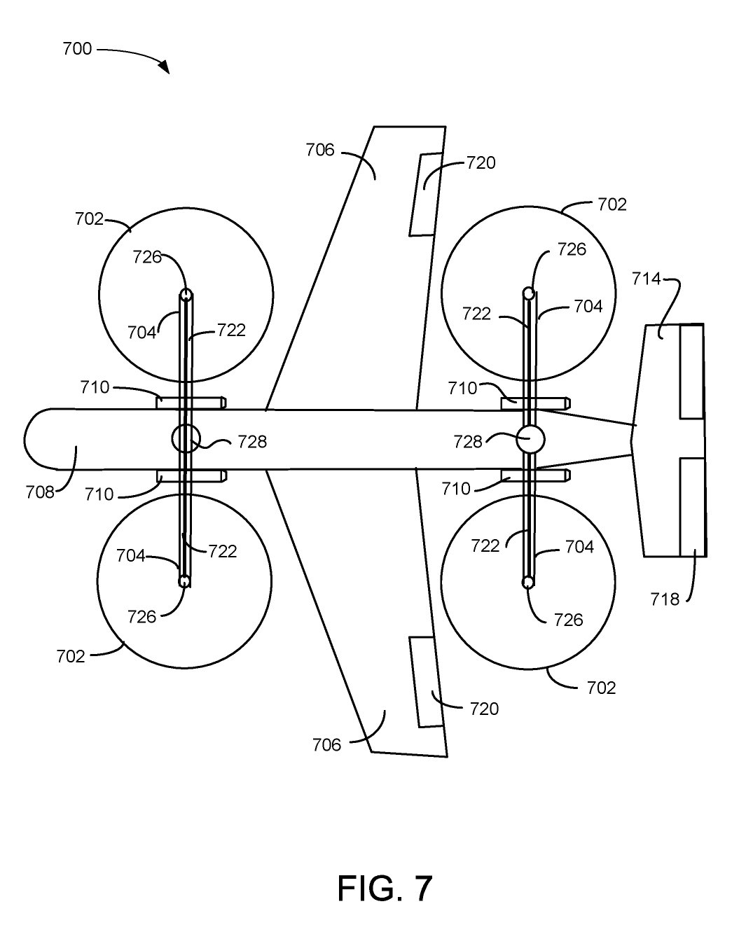

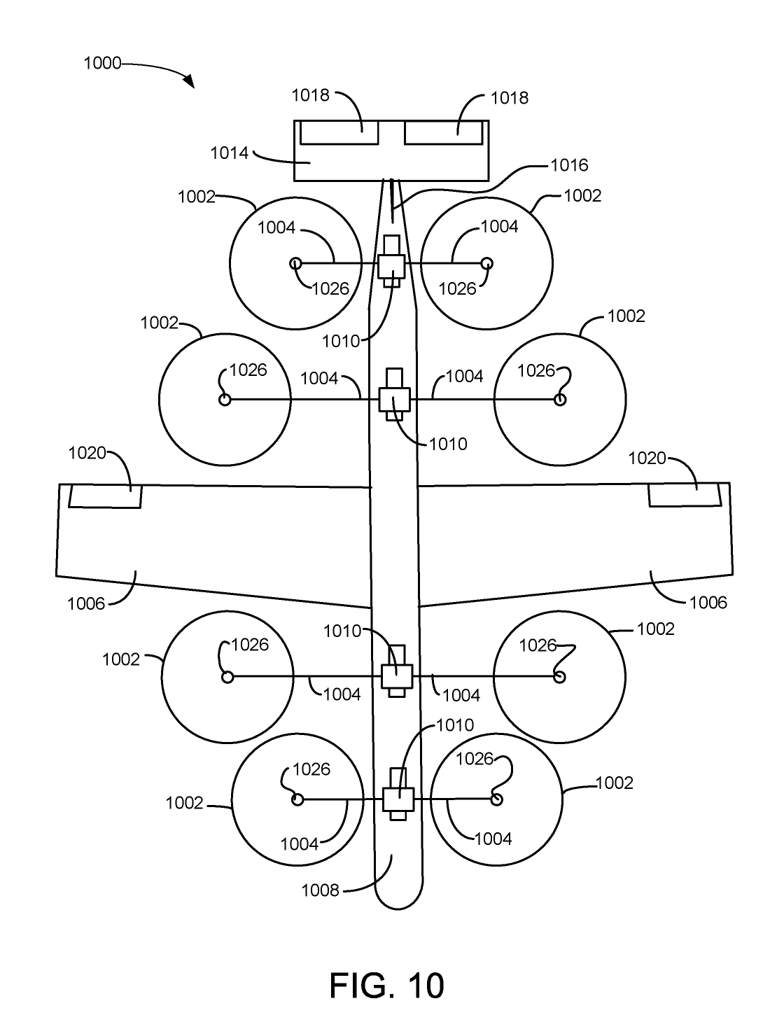

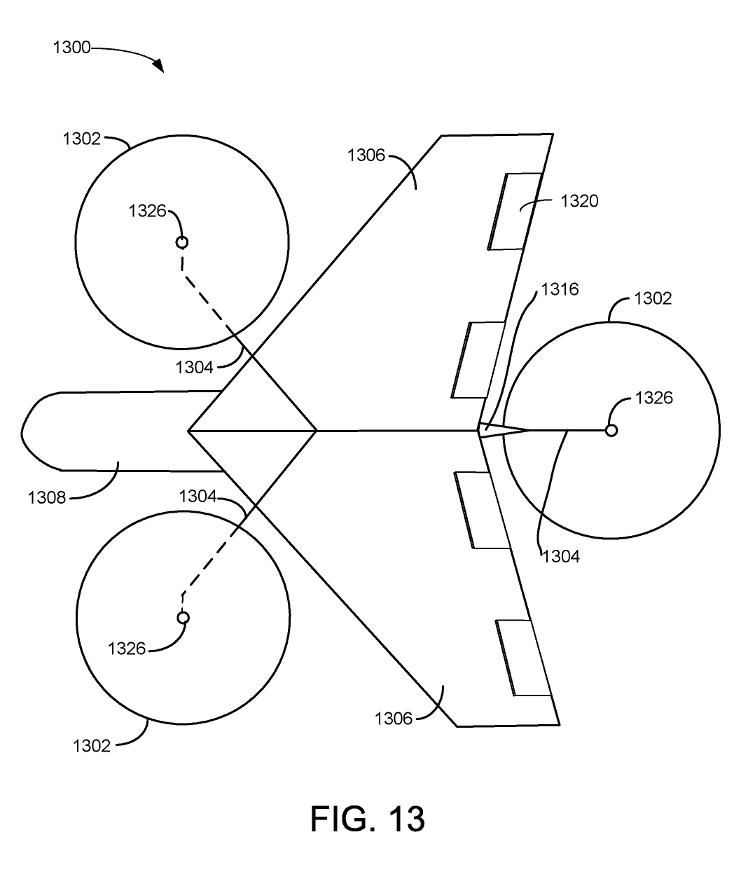

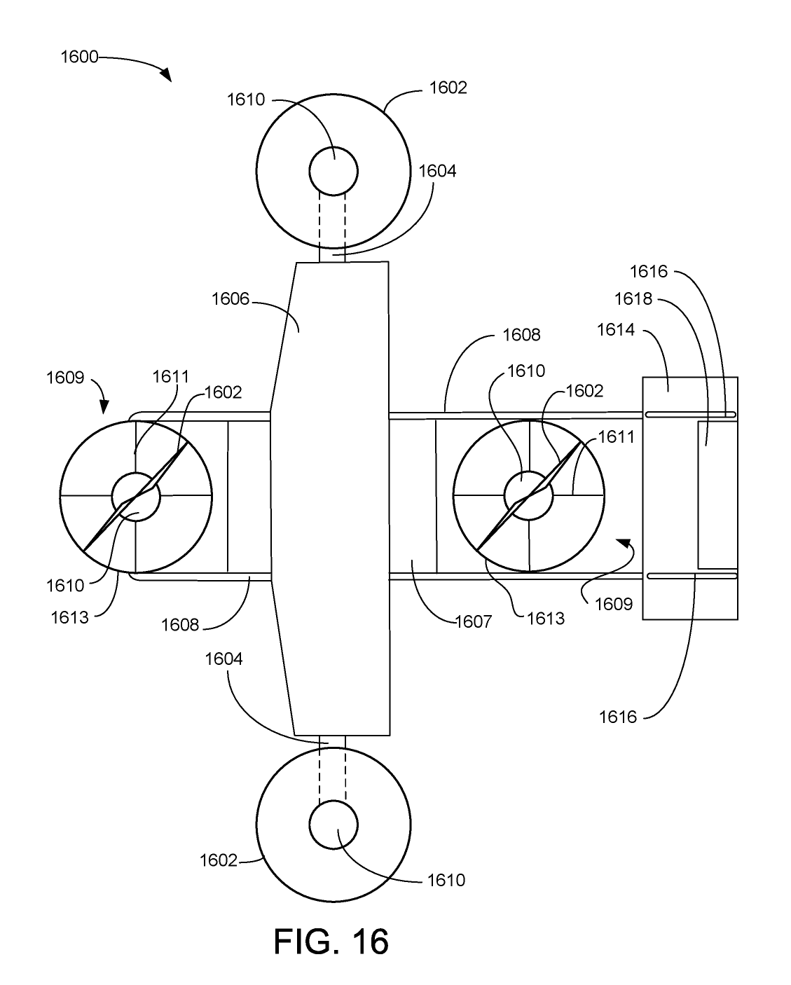

Rotors 102 may be rigid or, for heavy lift aircraft, flexible. While all rotors 102, 402 (see FIG. 4), 702 (see FIG. 7), 1002 (see FIG. 10), 1302 (see FIGS. 13) and 1602 (see FIG. 16) are shown as being the same size, rotor size is not a limitation of the invention. In some embodiments, both rigid and flexible rotors may be used. In particular embodiments, so vertical lift rotors may be fixed. In some embodiments, wings 106, 406, (see FIG. 4), 706 (see FIG. 7), 1006 (see FIG. 10), 1306 (see FIGS. 13) and 1606 (see FIG. 16) may be swept forward or swept back.

The long axis 128 of the fixed-wing VTOL aircraft 100 defines a line of symmetry for the arrangement of rotors 102. Rotors 102 are arranged in sets of first and second rotors, spaced apart on opposite sides of the fuselage 108, with a first set forward of the wings 106 and a second set aft of the wings 106, as shown.

Each outrigger 104 supports a rotational coupling 126 linking each respective driveshaft 122 to each respective rotor 102, enabling rotation of the powered rotors 102 relative to their respective outriggers 104. The rotors 102 are diagrammed in this view in a vertical flight configuration, with the forward rotors 102 above their respective outriggers 104 and the rear rotors 102 below their respective outriggers 104. By illustrating the rotors 102 as circles, the absence of thrust obstruction by the wings 106 and by the fuselage 108 can be clearly seen.

In some embodiments, force to propel the rotors 102 may be provided by pneumatics, hydraulics, or rotor-tip jets, rather than the motor 110, motor output shaft 124, and drive shafts 122. Such variation is available in all embodiments. The shape of the illustrated fuselage 108 and airfoils 106, 114,116, 118, and 120 are not limitations of the invention. Rather, the outriggers 104 housing drive shafts 122 to four rotors 102 supporting articulatible couplings 126, with two rotors 102 forward of the wing 106 and two rotors 102 aft of the wing 106 represents a novel feature of the invention.

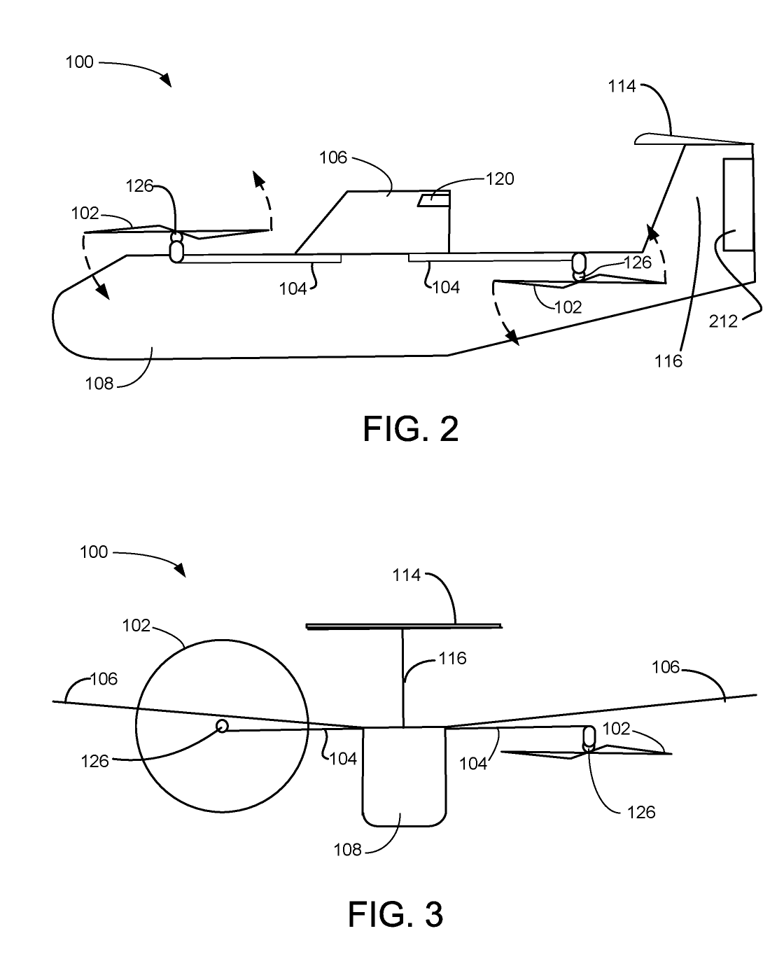

FIG. 2 is a side elevation diagrammatic view illustrating the exemplary embodiment of the fixed-wing VTOL aircraft 100 with rotors 102 on outriggers 104 of FIG. 1, according to a preferred embodiment of the present invention. The couples of dashed-line arrows illustrate the directional of rotation for forward rotors 102 and rear rotors 102 from a vertical thrust position (as shown) to a wing-borne flight forward thrust position. Flight control surface 212, such as a rudder 212, is shown on vertical stabilizer 116. Notice that the outriggers 104 are below the wings 106. Horizontal stabilizer 114 in not impinged by rotation of the rear rotors 102.

FIG. 3 is a front elevation diagrammatic view illustrating the exemplary embodiment of the fixed-wing VTOL aircraft 100 with rotors 102 on outriggers 104 of FIG. 1 in a non-flight configuration, according to a preferred embodiment of the present invention. A non-flight configuration is shown to illustrate that rotor 102 (on the viewer's left), in a wing-borne flight forward thrust position ,does not extend below the fuselage 108 and so this aircraft 100 could, in an embodiment equipped with landing gear, take off and land horizontally as well as vertically, as illustrated by rotor 102 (on the viewer's right).

FIG. 4 is a top plan diagrammatic view illustrating a second exemplary embodiment of the fixed-wing VTOL aircraft 400 with rotors 402 on outriggers 404, according to a preferred embodiment of the present invention. Fuselage 408, including structural members therein, support wings 406 with flight control surfaces 420 (such as ailerons 420) and a vertical stabilizer 416 further supporting horizontal stabilizer 414 having a flight control surface 418 (such as an elevator 418). Wings 406 further support outriggers 404 which house drive shafts coupled between motors 410, which motors 410 are located under their respective wings 406. Motor 410 may, in various embodiments, be any type of motor, from a battery-operated electric motor for a toy drone to a combustion motor (piston or jet) for a large aircraft. Transfer of power from the motor 410 to the rotors 402 may be similar to the embodiment of FIG. 1. Rotors 402 are arranged in sets of first and second rotors 402, spaced apart on opposite sides of the fuselage 408, with a first set forward of the wings 406 and a second set aft of the wings 406, as shown.

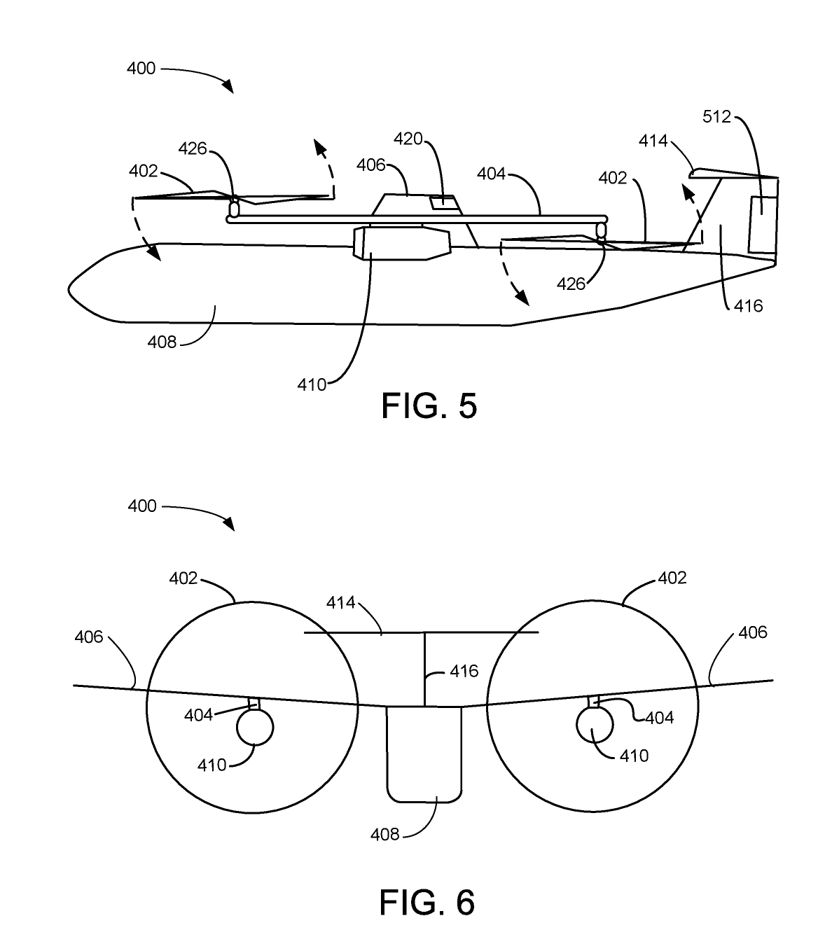

Each outrigger 404 supports a rotational coupling 426 linking each respective driveshaft to each respective rotor 402, enabling rotation of the powered rotors 402 relative to their respective outriggers 404. The rotors 402 are diagrammed in a vertical flight configuration, with the forward rotors 402 above their respective outriggers 404 and the rear rotors 402 below their respective outriggers 404. By illustrating the rotors 402 as circles, the absence of thrust obstruction by the wings 406 and by the fuselage 408 can be clearly seen. The shape of the illustrated fuselage 408 and airfoils 406, 512 (see FIGS. 5), 414, 416, 418, and 420 are not limitations of the invention. Rather, the outriggers 404 housing drive shafts 122 to four rotors 102 supporting articulatible couplings 126, with two rotors 102 forward of the wing 106 and two rotors 102 aft of the wing 106 represents a novel feature of the invention. The use of two wing mounted motors 410 to drive the drive shafts (not shown, but as with FIG. 1) within the outriggers 404 is also a novel feature of the invention.

FIG. 5 is a side elevation diagrammatic view illustrating the second exemplary embodiment of the fixed-wing VTOL aircraft 400 with rotors 402 on outriggers 404 of FIG. 4, according to a preferred embodiment of the present invention. The couples of dashed-line arrows illustrate the directional of rotation for forward rotors 402 and rear rotors 402 from a vertical thrust position to a wing-borne flight forward thrust position. Flight control surface 512, such as a rudder 512, is shown on vertical stabilizer 416. Notice that the outriggers 1404 are below the wings 406. Horizontal stabilizer 414 in not impinged by rotation of the rear rotors 402. The view of wing 406 is of the underside of the wing 406.

FIG. 6 is a front elevation diagrammatic view illustrating the second exemplary embodiment of the fixed-wing 406 VTOL aircraft 400 with rotors 402 on outriggers 404 of FIG. 4, according to a preferred embodiment of the present invention. Rotors 402 extend below the fuselage 408 during forward flight, requiring this embodiment to take off and land vertically. In a particular embodiment, landing gear extending from the bottom of the fuselage may be added to enable horizontal takeoff and landing.

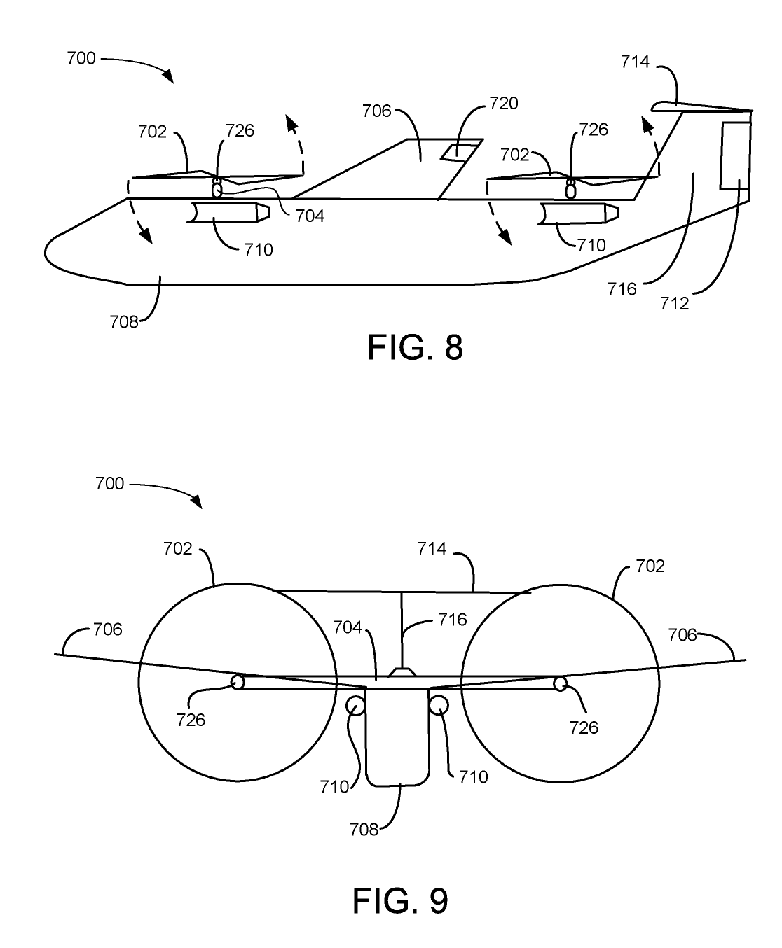

FIG. 7 is a top plan diagrammatic view illustrating a third exemplary embodiment of the fixed-wing 706 VTOL aircraft 700 with rotors 702 on outriggers 704, according to a preferred embodiment of the present invention. Fixed-wing VTOL aircraft 700 is shown in a vertical flight configuration. Fixed-wings 706, extending from fuselage 708, have ailerons 720. Vertical stabilizer 716 (see FIG. 8) extends from fuselage 708 and supports rudder 712 (see FIG. 8) and horizontal stabilizer 714. Horizontal stabilizer 714 supports flight control surfaces 718 (one of two labeled), such as elevators 718. Engines 710 transfer power to gear boxes 728 which transfer power via drive shafts 722 within outriggers 704. Outriggers 704 support rotational couplings 726 to drive and articulate rotors 702. Gear boxes 728 are preferably supported on supports for outriggers 704 on or within the fuselage 708. Rotors 702 are arranged in sets of first and second rotors 702, spaced apart on opposite sides of the fuselage 708, with a first set forward of the wings 706 and a second set aft of the wings 706, as shown.

The shape of the illustrated fuselage 708 and airfoils 706, 712 (see FIGS. 8), 714, 716, 718, and 720 are not limitations of the invention. Rather, the outriggers 704 housing drive shafts 722 to four rotors 702 supporting articulatible couplings 726, with two rotors 702 forward of the wing 706 and two rotors 702 aft of the wing 706 represents a novel feature of the invention. The use of four external fuselage-mounted motors 710 to drive the drive shafts 722 within the outriggers 704 is also a novel feature of the invention.

FIG. 8 is a side elevation diagrammatic view illustrating the third exemplary embodiment of the fixed-wing 706 VTOL aircraft with rotors 702 on outriggers 704 of FIG. 7, according to a preferred embodiment of the present invention. The couples of dashed-line arrows illustrate the directional of rotation for forward rotors 702 and rear rotors 702 from a vertical thrust position to a wing-borne flight forward thrust position. The view of wing 706 is of the underside of the wing 706.

FIG. 9 is a front elevation diagrammatic view illustrating the third exemplary embodiment of the fixed-wing 706 VTOL aircraft 700 with rotors 702 on outriggers 704 of FIG. 7, according to a preferred embodiment of the present invention. Rotors 702 do not extend below the fuselage 708 during forward flight, enabling this embodiment to take off and land horizontally or vertically. In a particular embodiment, landing gear may be added to this embodiment to facilitate horizontal landing.

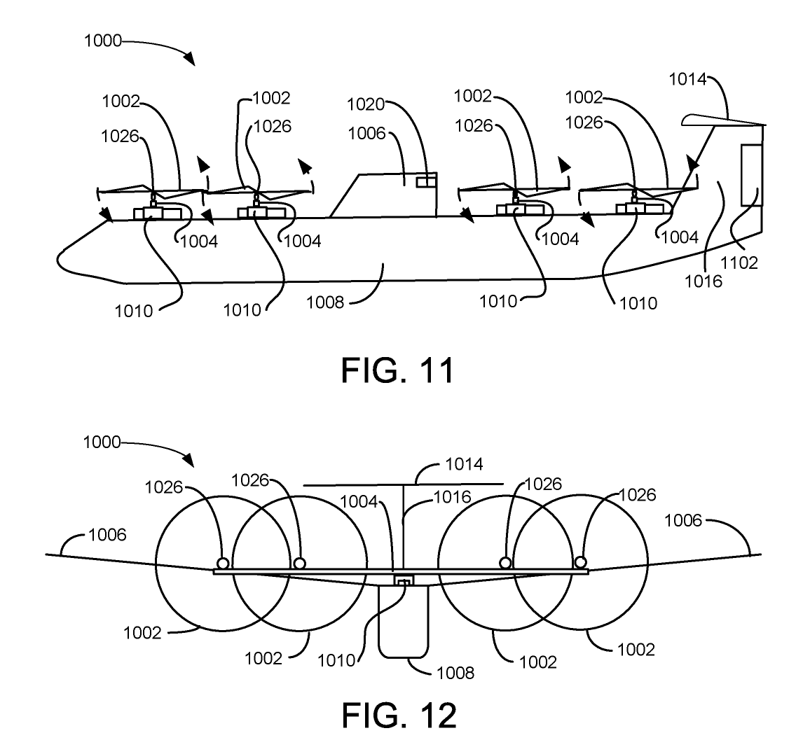

FIG. 10 is a top plan diagrammatic view illustrating a fourth exemplary embodiment of the fixed-wing 1006 VTOL aircraft 1000 with rotors 1002 on outriggers 1004, according to a preferred embodiment of the present invention. Wings 1006 extend from fuselage 1008 and support ailerons 1020, or similar flight control surfaces 1020. Vertical stabilizer 1016 (see FIG. 11) extends from fuselage 1008 and supports rudder 1102 (see FIG. 11) and horizontal stabilizer 1014. Four motors 1010, located partially within the fuselage 108, transfer power to drive shafts (not shown, but as with FIG. 1) within outriggers 1004 to rotational couplings 1026. Rotational couplings 1026 transfer power to rotors 1002 and articulate the rotors 1002 between the vertical flight and wing-borne flight forward flight modes. Rotors 1002 are arranged in sets of first and second rotors 1002, spaced apart on opposite sides of the fuselage 1008, with first and second sets forward of the wings 1006 and third and fourth sets aft of the wings 1006, as shown. The lift between the forward and aft sets of rotors 1002 is preferably balanced about the center of mass of the aircraft 100, which is preferably near the center of lift provided by wings 1006. As for all of the embodiments, the transition from vertical to wing-borne flight forward mode is controlled by a control system which may be entirely onboard the aircraft or may be partially onboard and partially off board, as with remotely controlled aircraft.

A particular advantage of the present embodiment is that one pair of rotors 1002 forward of the wings 1006 and one pair of rotors 1002 aft of the wings 1006 may be transitioned to wing-borne flight forward mode before the remaining pairs of rotors 1002, to smooth the transition to wing-borne flight forward mode. The shape of the illustrated fuselage 1008 and airfoils 1006, 1012 (see FIGS. 8), 1014, 1016, 1018, and 1020 are not limitations of the invention. Rather, the outriggers 1004 housing drive shafts 1022 to four rotors 1002 supporting articulatible couplings 1026, with two rotors 1002 forward of the wing 1006 and two rotors 1002 aft of the wing 1006 represents a novel feature of the invention. The use of four semi-external fuselage-mounted motors 1010 to drive the drive shafts (not shown) within the outriggers 1004 is also a novel feature of the invention.

FIG. 11 is a side elevation diagrammatic view illustrating the fourth exemplary embodiment of the fixed-wing 1006 VTOL aircraft 1000 with rotors 1002 on outriggers 1004 of FIG. 10, according to a preferred embodiment of the present invention. This view shows motors 110 partially within the fuselage 1008. As shown in FIG. 10, the rotors 1002 do not contact one another in any flight mode.

FIG. 12 is a front elevation diagrammatic view illustrating the fourth exemplary embodiment of the fixed-wing 1006 VTOL aircraft 1000 with rotors 1002 on outriggers 1004 of FIG. 10, according to a preferred embodiment of the present invention. Preferably, the control system onboard synchronizes the rotors 1002 to provide steady air flow over the wings 1006, vertical stabilizer 1016, and horizontal stabilizer 1014. Avoidance of flow resonances is preferred. Rotors 1002 do not extend below the fuselage 1008 during forward flight, enabling this embodiment to take off and land horizontally or vertically. In a particular embodiment, landing gear may be added to this embodiment to facilitate horizontal landing.

FIG. 13 is a top plan diagrammatic view illustrating a fifth exemplary embodiment of the fixed-wing 1306 VTOL aircraft 1300 with rotors 1302 on outriggers 1304, according to a preferred embodiment of the present invention. VTOL aircraft 1300 is shown in a vertical flight configuration. Swept wings 1306 extend from the top of fuselage 1308 and support flight control surfaces 1320 (one of four labeled). Vertical stabilizer 1316 also extends from fuselage 1308. Outriggers 1304 support rotational couplings 1326 which transfer power to rotor 1302 and articulate rotors 1302 between vertical flight and wing-borne flight forward modes. The shape of the illustrated fuselage 1308 and airfoils 1306, 1316, and 1320 are not limitations of the invention. Rather, the outriggers 1304 housing drive shafts (not shown, but as in FIG. 1) to three rotors 1302 supporting articulatible couplings 1326, with two rotors 1302 forward of the wing 1306 and one rotor 1302 aft of the wing 1306 represents a novel feature of the invention. The use of a counter-rotating rotor 1402 with each rotor 1302 where the rotor pairs 1302, 1402 are pair-wise articulatible, is also a novel feature of the invention. Use of a single, internally fuselage-mounted motor 1410 to drive the drive shafts (not shown) within the outriggers 1304 is also a novel feature of the invention. Rotors 1302 are arranged in a set of first and second rotors 1302, spaced apart on opposite sides of the fuselage 1308, with first and second rotors 1302 forward of the wings 406 and a third rotor 1302 aft of the wings 1306 ,as shown.

The shape of the illustrated fuselage 1308 and airfoils 1306, 1316, and 1320 are not limitations of the invention. Rather, the outriggers 1304 housing drive shafts (not shown, but as in FIG. 1) to three rotors 1302 supporting articulatible couplings 1326, with two rotors 1302 forward of the wing 1306 and one rotor 1302 aft of the wing 1306 represents a novel feature of the invention. The use of a counter-rotating rotor 1402 with each rotor 1302 where the rotor pairs 1302, 1402 are pair-wise articulatible, is also a novel feature of the invention. Use of a single, internally fuselage-mounted motor 1410 to drive the drive shafts (not shown) within the outriggers 1304 is also a novel feature of the invention.

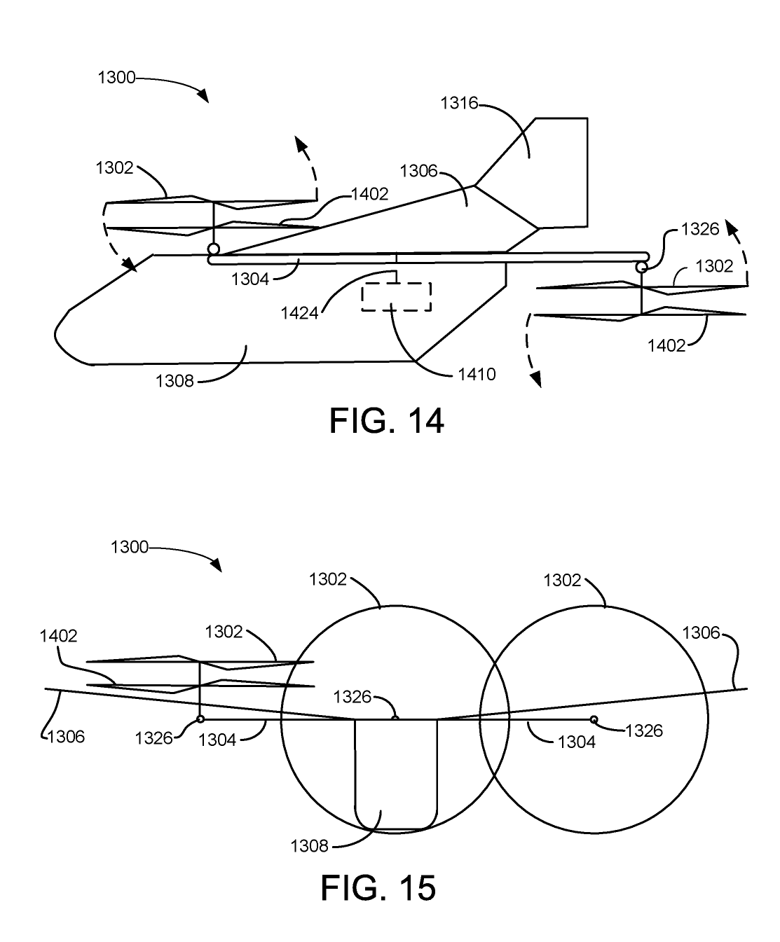

FIG. 14 is a side elevation diagrammatic view illustrating the fifth exemplary embodiment of the fixed-wing 1306 VTOL aircraft 1300 with rotors 1302 on outriggers 1304 of FIG. 13, according to a preferred embodiment of the present invention. A single motor 1410 provides power to all rotor pairs 1302 and 1402 via drive shafts in outriggers 1304. All rotors 1302 have counter-rotating rotors 1402 in order to reduce net torque. Forward rotor pairs 1302 and 1402 are mounted above the outriggers 1304 to enable rotation without impact with the outriggers 1304. Rear rotor pair 1302 and 1402 is mounted below the outrigger 1304 for the same reason. The control system will control the rotor velocity between the two front rotors and the rear rotor to compensate for any changes in the center of mass due to fuel consumption. The couples of dashed-line arrows illustrate the directional of rotation for forward rotor pairs 1302 and 1402 and rear rotor pair 1302 and 1402 from a vertical thrust position to a wing-borne flight forward thrust position.

FIG. 15 is a front elevation diagrammatic view illustrating the fifth exemplary embodiment of the fixed-wing 1306 VTOL aircraft 1300 with rotors 1302 and 1402 on outriggers 1304 of FIG. 13 in a non-flight configuration, according to a preferred embodiment of the present invention. Because rear rotor 1302 extends below the fuselage, as shown, horizontal takeoff and landing is unsafe. In some embodiments, landing gear extending from the underside of fuselage 1308 may enable safe horizontal takeoffs and landings.

FIG. 16 is a top plan diagrammatic view illustrating a fifth exemplary embodiment of the fixed-wing 1606 VTOL aircraft 1600 with rotors 1602 on outriggers 1604, according to a preferred embodiment of the present invention. Double parallel spaced apart fuselage members 1608 support fixed-wing 1606, vertical stabilizers 1616, and horizontal stabilizer 1614 on top of the fuselage members 1608. Horizontal stabilizer 1614 supports elevator 1618. Between double parallel spaced apart fuselage members 1608 are supported front thrust assembly 1609; inner wing 1607, and rear thrust assembly 1609. Each thrust assembly 1609 includes a cowling 1613, a motor 1610 supported 1611 (one of four labeled) in the cowling 1613, and a rotor 1602 driven by the motor 1610. Each thrust assembly 1609 can be rotated between a vertical flight configuration, as shown, to a wing-borne flight forward thrust configuration about an axis between the fuselage members 1608. Inner wing 1607 may serve, at least in part, as a fuel tank. Outriggers 1604 extend from wings 1606 and support motors 1610 which drive rotors 1602. Outrigger-mounted motors 1610 are articulated by rotation of the outrigger 1604. Rotors 1602 are arranged in sets of first and second rotors 1602, spaced apart on opposite sides of the fuselage 1608, with first and second rotors 1602 aligned to the chord of the wings 1606, as shown. First and second thrust assemblies 1609 are arranged with one forward of the wings 1606 and one aft of the wings 1606, as shown.

The shape of the illustrated fuselage members 1608 and airfoils 1606, 1607, 1612 (see FIGS. 18), 1614, 1616, and 1618 are not limitations of the invention. Rather, the outriggers 1604 to two motors 1610 driving rotors 1602, with two rotors 1602 outboard of the wings 1606 and two thrust assemblies 1609 between fuselage members 1608 represents a novel feature of the invention. The articulation of the two outboard motors 1610 to using the outriggers 1604 is also a novel feature of the invention. The use of inner wing 1607 as a fuel tank is also a novel feature of the invention.

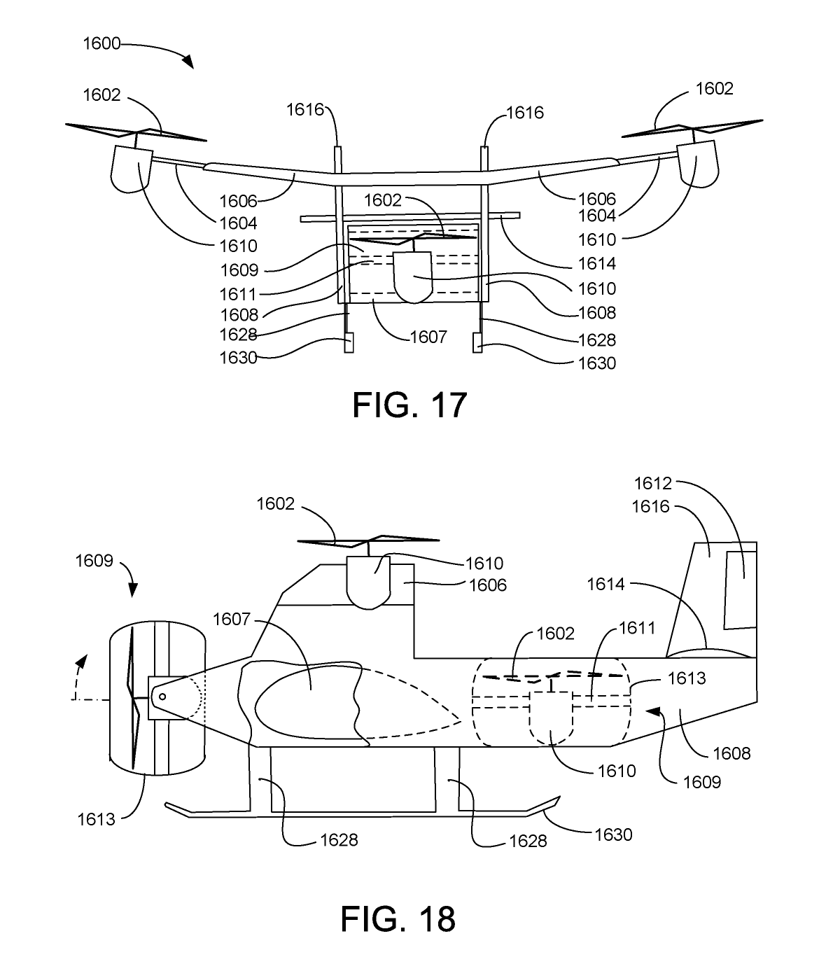

FIG. 17 is a front elevation diagrammatic view illustrating the fifth exemplary embodiment of the fixed-wing 1606 VTOL aircraft 1600 with rotors 1602 on outriggers 1604 of FIG. 16, according to a preferred embodiment of the present invention. Landing gear supports 1628 supports skis 1630 for ice and snow landings. In another embodiment, landing gear supports 1628 may support wheels.

FIG. 18 is a side elevation diagrammatic view illustrating the fifth exemplary embodiment of the fixed-wing 1606 VTOL aircraft 1600 with rotors 1602 on outriggers of FIG. 16 with a cut-away portion and in a non-flight configuration, according to a preferred embodiment of the present invention. The forward thrust assembly 1609 is shown in a wing-borne flight forward thrust position with a dashed arrow showing the direction of rotation to a vertical flight position. Thrust assemblies 1609 have at least a ninety angular degree freedom of movement. Cowling 1613 can best be seen in this view. The cutaway portion best shows inner wing 1607. Fuselage 1608 supports vertical stabilizer 1616 which supports rudder 1612. The rear thrust assembly 1609 and outrigger-mounted motor 1610 are shown in vertical flight positions.

The embodiments illustrated herein are merely exemplary, and do not define the limits of the invention. In some embodiments, for example, the rotors 102, 402, 702, 1002, 1302, or 1602 may be capable of rotation beyond ninety degrees and may rotate sideways. The limits of the invention are described in the claims below.

I claim:

1. A vertical takeoff and landing aircraft comprising:
a. a fixed-wing aircraft;
b. a plurality of outriggers extending from said fixed-wing aircraft; and
c. an articulatible rotor mounted on each outrigger of said plurality of outriggers.

2. The vertical takeoff and landing aircraft of claim 1, comprising:
a. a drive shaft in each said outrigger of said plurality of outriggers; and
b. at least one motor adapted to drive said plurality of drive shafts.

3. The vertical takeoff and landing aircraft of claim 2, wherein said plurality of outriggers is arranged to support at least two counter-rotating pairs of rotors on opposed sides of said fixed-wing aircraft, wherein said at least two counter-rotating pairs of rotors are arranged symmetrically with respect to a long axis of said fixed-wing aircraft.

4. The vertical takeoff and landing aircraft of claim 3, wherein said plurality of outriggers is arranged to support at least two counter-rotating rotors at an aft end of said fixed-wing aircraft.

5. The vertical takeoff and landing aircraft of claim 2, wherein said plurality of outriggers is arranged to support at least first and second rotors spaced apart on opposed sides of said fixed-wing aircraft, wherein said articulatible rotors are arranged symmetrically with respect to a long axis of said fixed-wing aircraft.

6. The vertical takeoff and landing aircraft of claim 5, comprising:
a. a first set of said articulatible rotors of said at least first and second said articulatible rotors positioned forward of a fixed-wing of said fixed-wing aircraft; and
b. a second set of said articulatible rotors of said at least first and second articulatible rotors positioned aft of said fixed-wing of said fixed-wing aircraft.

7. The vertical takeoff and landing aircraft of claim 6, wherein said at least one motor comprises one motor for each said set of said articulatible rotors.

8. The vertical takeoff and landing aircraft of claim 1, wherein said articulatible rotor comprises a rotational coupling mounted on said outrigger and supporting said rotor.

9. The vertical takeoff and landing aircraft of claim 8, wherein said rotational coupling is adapted to rotate said articulatible rotor at least between a vertical flight position and a wing-borne flight forward thrust position.

10. The vertical takeoff and landing aircraft of claim 1, comprising first and second fuselage members, spaced apart and parallel, and having there between:
a. a first articulatible thrust assembly mounted forward of a fixed-wing of said fixed-wing aircraft;
b. an inner wing extending between said first and second fuselage members and positioned underneath said fixed-wing.; and
c. a second articulatible thrust assembly mounted aft of said fixed-wing of said fixed-wing aircraft.

11. The vertical takeoff and landing aircraft of claim 10, comprising
a. first and second rotatable outriggers extending from first and second ends of said fixed-wing;
b. first and second motors supported on said first and second rotatable outriggers; and
c. first and second rotors adapted to be driven by said first and second motors.

12. A vertical takeoff and landing aircraft comprising:
a. a fixed-wing aircraft;
b. a plurality of outriggers extending from said fixed-wing aircraft;
c. an articulatible rotor mounted on each outrigger of said plurality of outriggers;
d. a drive shaft in each said outrigger of said plurality of outriggers; and
e. at least one motor adapted to drive said plurality of drive shafts.

13. The vertical takeoff and landing aircraft of claim 12, wherein
a. said plurality of outriggers is arranged to support at least two counter-rotating pairs of rotors on opposed sides of said fixed-wing aircraft, wherein said at least two counter-rotating pairs of rotors are arranged symmetrically with respect to a long axis of said fixed-wing aircraft; and
b. said plurality of outriggers is arranged to support at least two counter-rotating rotors at an aft end of said fixed-wing aircraft.

14. The vertical takeoff and landing aircraft of claim 12, wherein said plurality of outriggers is arranged to support at least first and second rotors spaced apart on opposed sides of said fixed-wing aircraft, wherein said articulatible rotors are arranged symmetrically with respect to a long axis of said fixed-wing aircraft.

15. The vertical takeoff and landing aircraft of claim 14, comprising:
a. a first set of said articulatible rotors of said at least first and second said articulatible rotors positioned forward of a fixed-wing of said fixed-wing aircraft; and
b. a second set of said articulatible rotors of said at least first and second articulatible rotors positioned aft of said fixed-wing of said fixed-wing aircraft.

16. The vertical takeoff and landing aircraft of claim 15, wherein said at least one motor comprises one motor for each said set of said articulatible rotors.

17. The vertical takeoff and landing aircraft of claim 12, wherein:
a. said articulatible rotor comprises a rotational coupling mounted on said outrigger and supporting said rotor; and
b. wherein said rotational coupling is adapted to rotate said articulatible rotor between at least a vertical flight position and a wing-borne flight forward thrust position.

18. The vertical takeoff and landing aircraft of claim 12, comprising first and second fuselage members, spaced apart and parallel, and having there between:
a. a first articulatible thrust assembly mounted forward of a fixed-wing of said fixed-wing aircraft;
b. an inner wing extending between said first and second fuselage members and positioned underneath said fixed-wing;
c. a second articulatible thrust assembly mounted aft of said fixed-wing of said fixed-wing aircraft;
d. first and second rotatable outriggers extending from first and second ends of said fixed-wing;
e. first and second motors supported on said first and second rotatable outriggers; and
f. first and second rotors adapted to be driven by said first and second motors.

19. A vertical takeoff and landing aircraft, comprising:
a. a fixed-wing aircraft;
b. a plurality of outriggers extending from said fixed-wing aircraft;
c. an articulatible rotor mounted on each outrigger of said plurality of outriggers;
d. a drive shaft in each said outrigger of said plurality of outriggers;
e. at least one motor adapted to drive said plurality of drive shafts;
f. an arrangement of said plurality of outriggers adapted to support at least first and second rotors spaced apart on opposed sides of said fixed-wing aircraft, wherein said articulatible rotors are arranged symmetrically with respect to a long axis of said fixed-wing aircraft;
g. a first set of said articulatible rotors of said at least first and second said articulatible rotors positioned forward of a fixed-wing of said fixed-wing aircraft; and
h. a second set of said articulatible rotors of said at least first and second articulatible rotors positioned aft of said fixed-wing of said fixed-wing aircraft;
i. wherein said at least one motor comprises one motor for each said set of said articulatible rotors;
j. said articulatible rotor comprises a rotational coupling mounted on said outrigger and supporting said rotor; and
k. wherein said rotational coupling is adapted to rotate said articulatible rotor between at least a vertical flight position and a wing-borne flight forward thrust position.

20. The vertical takeoff and landing aircraft of claim 19, wherein
a. said plurality of outriggers is arranged to support at least two counter-rotating pairs of rotors on opposed sides of said fixed-wing aircraft, wherein said at least two counter-rotating pairs of rotors are arranged symmetrically with respect to a long axis of said fixed-wing aircraft; and
b. said plurality of outriggers is arranged to support at least two counter-rotating rotors at an aft end of said fixed-wing aircraft.
